(19) United States
(12) Patent Application Publication
(10) Pub. No.: US 2003/0116490 A1
(43) Pub. Date: Jun. 26, 2003

(54) Fuel filter assembly with an integrated fuel heater

(75) Inventors: Eric S. Keyster, Peoria, IL (US); Terry L. Miller, Morton, IL (US); Brett M. Bailey, Peoria, IL (US)

Correspondence Address: Michael McNeil, Liell & McNeil Attorneys PC, 511 S. Madison St., PO Box 2417, Bloomington, IN, 47401, US

(73) Assignee: Caterpillar, Inc., Peoria, IL

(21) Appl. No.: 10/029,410

(22) Filed: Dec. 20, 2001

(51) Int. Cl. B01D 35/18

(52) U.S. Cl. 210/184

(57) ABSTRACT

A fuel filter assembly includes a filter assembly housing with an annular outer surface and a fuel filter positioned within the filter assembly housing. A heater element is positioned between the annular outer surface of the filter assembly housing and the fuel filter. The fuel filter assembly is part of a fuel system attached to an engine. The filter assembly housing has an inlet and outlet. Fuel traveling through the fuel filter is heated by the heater element when the fuel temperature is below a predetermined temperature. The predetermined temperature preferably corresponds to a temperature below which paraffins form in the fuel. The invention assists in a cold start by avoiding a clogged fuel filter due to paraffin formation.

### TECHNICAL FIELD

The invention relates generally to fuel filters, and more particularly to fuel filters utilizing a heater to eliminate clogging of the fuel filter.

### BACKGROUND

In several diesel engines today, fuel filters conduct intense filtering of fuel before the fuel is injected in the engines. Fuel filters separate water and remove particulates from the fuel. However, depending on the formulation, cold weather causes diesel fuel to thicken due to the formation of paraffins, which in return, may clog fuel filters during a cold start. Engineers have attempted to prevent and limit this clogging of the fuel filters with varying methods. For instance, fuel additives that inhibit paraffin formation have been added to diesel fuel, and fuel blends have been altered to lower the temperature at which paraffins will form in the fuel. Further, in colder climates, the problem has been addressed by heating the fuel. For example, when the vehicle or machinery has been dormant for some time, block heaters may be connected to engine blocks in order to maintain the engine block at a temperature above which paraffins will form. Coils or disc shaped ceramic element heaters have been positioned at one end of the fuel filter in order to heat the fuel as it passes through the filter as shown in U.S. Pat. No. 5,244,571 issued to Church et al. on Sep. 14, 1993. Lastly, the heat produced by a working engine may also warm the fuel by utilizing fuel systems with a means to circulate warm fuel through the system as soon as possible after a cold start.

Although fuel additives, fuel blends and heaters have performed adequately, there is room for improvement. The fuel blends are varied by distillers depending upon the geographic region in which the fuel is intended for use, and thus, are not conducive to travel from a warm to a colder climate. Also, generally the fuel blends in which paraffins form at low temperatures are less economic. The element heaters positioned within the housing of the fuel filters are difficult to incorporate into existing fuel filter designs. Positioning a coil or disc-shaped heater below the filter element shortens the effective length of the filter element, displaces a volume of water and fuel, and unnecessarily utilizes energy heating the water that has been separated from the fuel. Element heaters also have a low heating potential due to the limited contact between the fuel and the heater. Moreover, the recirculation of warm fuel may prevent the formation of paraffins in cold weather after the engine has been running, but have a limited ability to prevent the formation of paraffins while an engine is dormant prior to and during a cold start.

The present invention is directed to one or more of the problems set forth above.

### SUMMARY OF THE INVENTION

In one aspect of the present invention, a fuel filter assembly has a filter assembly housing with an annular outer surface and a filter positioned within the filter assembly housing. The housing defines an inlet and an outlet. Between the outer surface of the filter assembly housing and the filter is a heater element.

In another aspect of the present invention, an engine has an engine housing and a fuel system attached to the engine housing. The fuel system includes a fuel filter assembly with a heater element positioned between a filter and an annular outer surface of a filter assembly housing.

In yet another aspect of the present invention, fuel is heated by incorporating a heater element in a fuel filter assembly between a filter and an annular outer surface of a filter assembly housing. The heater element is activated when the fuel temperature is below a predetermined temperature.

### BRIEF DESCRIPTION OF THE DRAWINGS

FIG. 1 is a schematic representation of an engine and a fuel system according to the preferred embodiment of the present invention;

FIG. 2 is a partially sectioned diagrammatic representation of a fuel filter assembly according to the preferred embodiment of the present invention.

FIG. 3a is a schematic representation of a heater element incorporated into the filter assembly housing according to the present invention.

FIG. 3b is a schematic representation of a heater element incorporated into the filter assembly housing according to another embodiment of the present invention.

### DETAILED DESCRIPTION

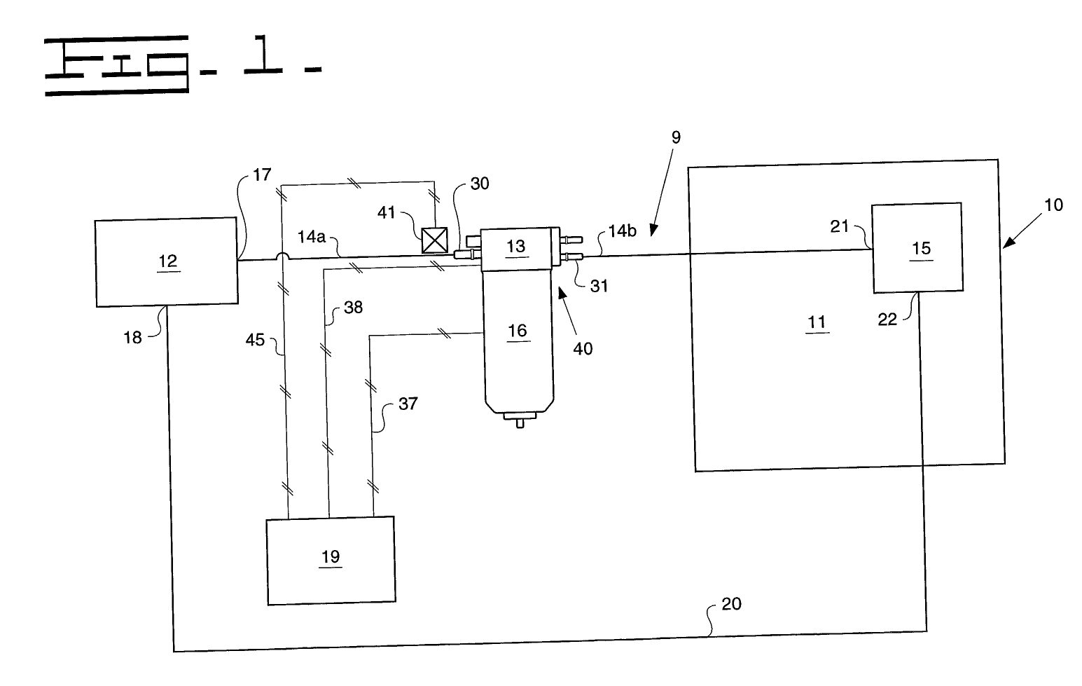

Referring to FIG. 1, there is shown a schematic representation of an engine 10 with an attached fuel system 9 according to the present invention. Engine 10 comprises an engine housing 11 to which the fuel system 9 is attached. A fuel tank 12 is provided within the fuel system 9 and has an outlet 17 that is in fluid communication with a upstream fuel supply line 14a and has an inlet 18 that is in fluid communication with a fuel return line 20. A fuel filter assembly 40 is included within the fuel system 9 and positioned in the supply line 14. It should be appreciated that the fuel filter assembly 40 may be attached to the engine housing 11 or the body of the vehicle or machinery. The fuel filter assembly 40 includes a fuel transfer pump 13 mounted on a fuel filter 16. The fuel filter 16 acts to trap precipitates and other solids from fuel flowing through the supply line 14, and to separate water from the fuel. The fuel transfer pump 13 has an inlet 30 in fluid communication with upstream supply line 14a and an outlet 31 in fluid communication with a downstream supply line 14b. The fuel transfer pump 13 is positioned to draw low pressure fuel out of the fuel tank 12 to pressurize the fuel and circulate the fuel to at least one fuel injector 15 provided within the engine 10. While the present invention is described for one fuel injector 15, it should be appreciated the present invention is applicable to an engine 10 housing any desired number of fuel injectors 15. The fuel injector 15 has a fuel inlet 21 that is in fluid communication with the downstream supply line 14b and a fuel outlet 22 in fluid communication with the return line 20. An electronic control module 19 is in communication with the fuel filter assembly 40 via a heater communication line 37. The electronic control module 19 is preferably in communication with the fuel transfer pump 13 via a pump communication line 38. Further, a temperature sensor 41 is preferably placed in the upstream supply line 14a in close proximity to the low pressure inlet 30 of the fuel transfer pump 13, but could be positioned at any other suitable location such as in fuel tank 12. The temperature sensor 41 is in communication with the electronic control module 19 via a temperature sensor communication line 45.

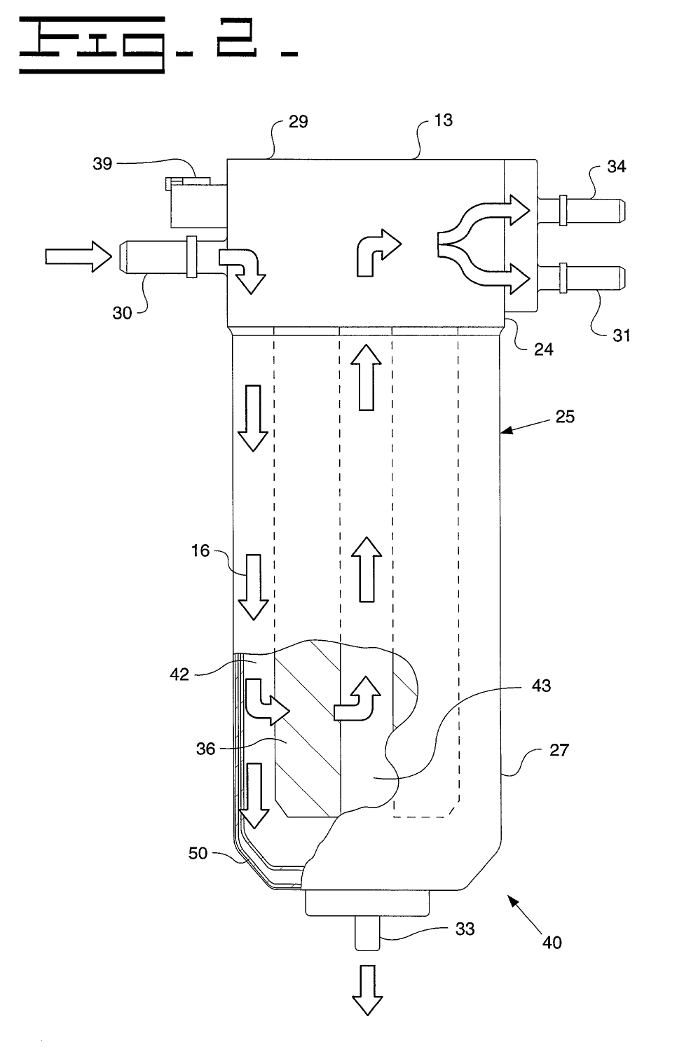

Referring to FIG. 2, there is shown a diagrammatic representation of a fuel filter assembly 40 according to the preferred embodiment of present invention. The fuel filter assembly 40 comprises a filter assembly housing 25, the fuel filter 16, and a heater element 50. The fuel transfer pump 13 is preferably included within the filter assembly housing 25. However, it should be appreciated that the fuel transfer pump 13 can also be positioned along the supply line 14 separate from the fuel filter 16. The heater element 50 is incorporated into the filter assembly housing 25. The heater element 50 is at least one of embedded into an inner wall 47 of the filter assembly housing 25, attached to the inner wall 47 of the filter assembly housing 25, and secured between the inner wall 47 of the filter assembly housing 25 and the fuel filter 16. The heater element 50 is preferably a wire comprised of material with a relatively high electrical resistance of a type often used in constructing so called thin film heaters. Those skilled in the art will appreciate that the heater element 50 may be of varying forms and made from varying materials with a suitable electrical resistance. The filter assembly housing 25 includes a pump housing 29 in which the fuel transfer pump 13 is positioned and a bowl assembly housing 27 in which the fuel filter 16 is positioned. The bowl assembly housing 27 has an annular outer surface 46 that is preferably cylindrical. The pump housing 29 defines the inlet 30 that is in fluid communication with the upstream supply line 14a and the outlet 31 that is in fluid communication with the downstream supply line 14b. The pump housing 29 also defines a pressure regulation outlet 34 connected to an inlet chamber of the fuel filter assembly 40 for venting air that is entrained in the diesel fuel or which is trapped in the fuel system 9 upon change of the fuel filter 16 from the fuel filter assembly 40.

The bowl assembly housing 27 of the filter assembly housing 25 is preferably threadably secured to a filter head assembly 24, and is removable from the filter head assembly 24. The fuel transfer pump 13 is mounted to the filter head assembly 24 opposite the bowl assembly housing 27 in which the fuel filter 16 is positioned. The fuel filter 16 is disposable, and can be removed from the bowl assembly housing 27 and replaced for maintenance purposes. Thus, the fuel filter 16 can be replaced without disposing of the bowl assembly housing 27 in which the heater element 50 is incorporated. Although the present invention is illustrated for a fuel filter 16 that is separable from the bowl assembly housing 27, the present invention may also be utilized with a fuel filter 16 that is attached to the bowl assembly housing 27 and is replaced along with the bowl assembly housing 27. The fuel filter 16 illustrated is an inverted-type filter in which the fuel filter 16 is suspended generally below the filter assembly head 24. Those skilled in the art will appreciate that the orientation of the fuel filter 16 and the fuel transfer pump 13 may be inverted or positioned in various other angular orientations defined by the dimensional constraints. The fuel filter 16 includes a filter element 36 comprised of a medium that is suitable for separating contaminants. The fuel element 36 defines outer peripheral fuel passages 42 and a central fuel passage 43. The fuel flows through the outer peripheral fuel passages 42 of the filter element 36 so that the particulate may be removed and the water separated from the fuel. The filtered fuel flows through the central fuel passage 43 towards the fuel transfer pump 13 as illustrated by the arrows in FIG. 2. The filter head assembly 24 is sealed to the bowl assembly housing 27 so the fuel paths remain constant. Due to its specific gravity, the water collects in the bottom cupped-shaped area of the bowl assembly housing 27. A water drain valve 33 is attached to the lower portion of the bowl assembly housing 27. In order to dispose of the collected water and to drain the bowl assembly housing 27 upon replacement of the fuel filter 16, the water drain valve 33 may be manually opened. Although the preferred embodiments include the water drain valve 33, other means of removing the collected water from the fuel filter 16 can be used, including but not limited to, a removable collection bowl attached at the lowest point of the bowl assembly housing 27.

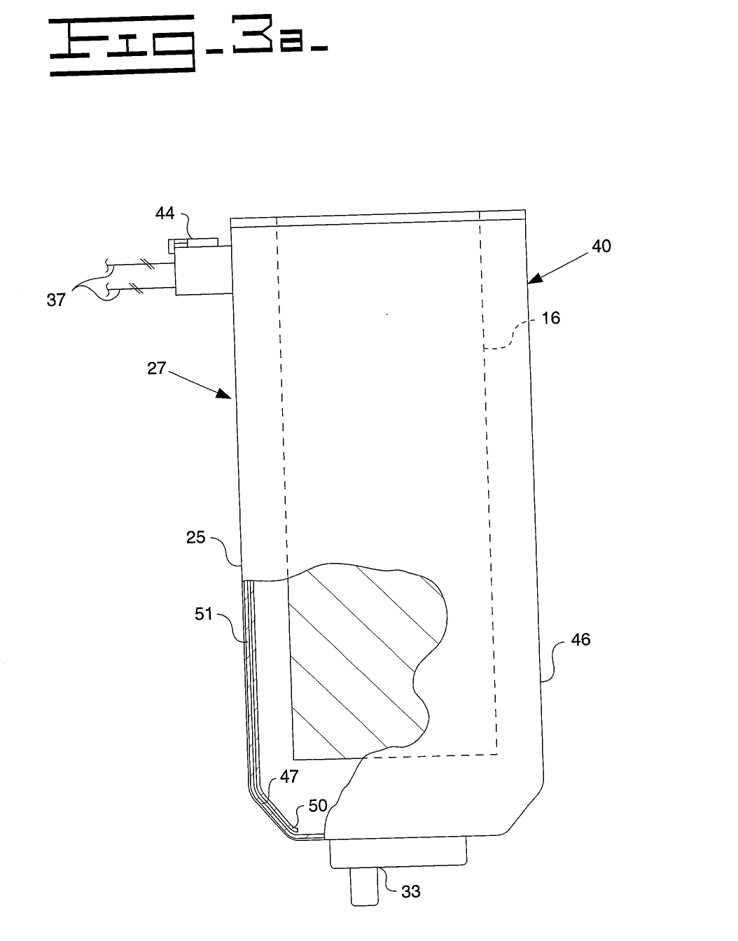

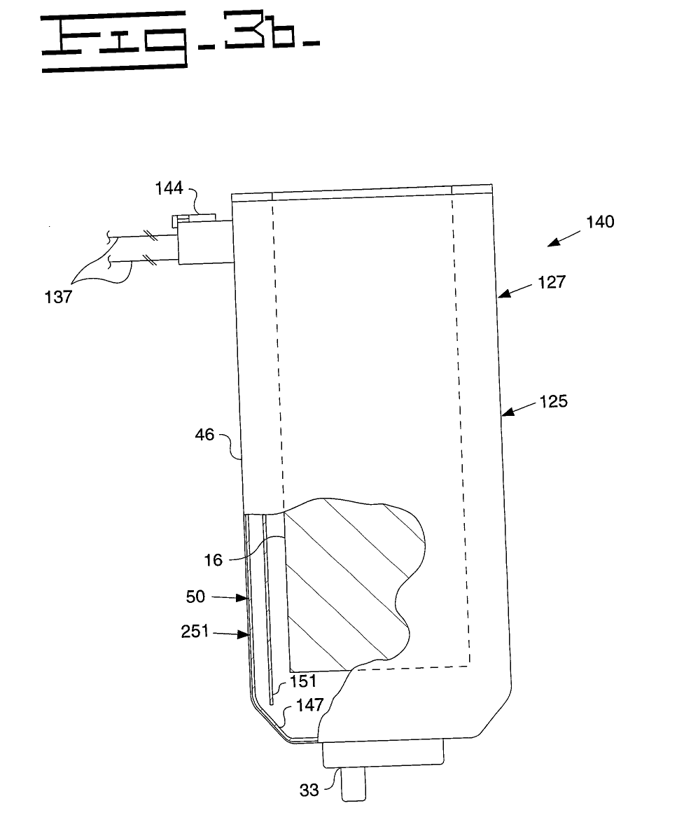

Referring to FIGS. 3a and 3b, there are shown schematic representations of the heater element 50 positioned within bowl assembly housing 27, 127 according to the preferred embodiments of the present invention. Features of the fuel filter assembly 140 that are identical to those of fuel filter assembly 40 will be given identical numbers. According to all preferred embodiments, the bowl assembly housing 27, 127 includes the heater element 50 that is positioned between the annular outer surface 46 of the bowl assembly housing 27, 127 and the fuel filter 16. The heater element 50 is positioned adjacent to the bowl assembly housing 27, 127. Although the bowl assembly housing 27, 127 is cylindrical according to the present invention, those skilled in the art will appreciate that the heater element 50 can be positioned within a bowl assembly housing 27, 127 of any shape. Incorporating the heater element 50 into the bowl assembly housing 27, 127 allows for a large cylindrical contact surface area that is desired for rapid heating of cold fuel.

Referring to FIG. 3a, there is shown a schematic representation of the heater element 50 incorporated into the bowl assembly housing 27 according to a preferred embodiment of the present invention. According to the first preferred embodiment, the heater element 50 is embedded into the inner wall 47 of the bowl assembly housing 27. A resistance heater is created by passing electric current through heater element 50 incorporated within the bowl assembly housing 27. The heater element 50, which preferably consists of one or more wires, is preferably positioned in a serpentine shape and molded into the material comprising the bowl assembly housing 27, preferably plastic. Those skill in the art should appreciate that compression molding is the preferred method for molding the wires of the heating element 50 into the plastic of the bowl assembly housing 27. However, other molding methods may be utilized. Alternatively, the heater element 50 may be first surrounded by layers of substrate before being embedded into the bowl assembly housing 27. The heater element 50 within the substrates is known to those skill in the art as a thin film heater 51. The thin film heater 51 is a type of resistance heater. The thin film heater 51 is preferably a few millimeters thick. Those skilled in the art will appreciate that the thin film heater 51 should be thick enough to produce sufficient heat to eliminate paraffin formation within the fuel but preferably thin enough that it may fit within the current geometry of the fuel filter 16. The thin film heater 51 could be molded into the inner wall 47 of the bowl assembly housing 27, preferably though a injection molding process.

According to the embodiment of the present invention illustrated in FIG. 3a, a heater electrical connector 44 is attached to the bowl assembly housing 27, preferably by molding the heater electrical connector 44 into the bowl assembly housing 27 at a point near the filter head assembly 24. It should be appreciated that the heater electrical connector 44 could be molded at any position on the bowl assembly housing 27. Further, the male and female portions of the heater electrical connector 44 could be molded and positioned into the housing of the filter head assembly 24 and the bowl assembly housing 27 such that an electrical connection is established when the bowl assembly housing 27 is attached to the filter head assembly 24. The heater electrical connector 44 is wired to the electronic control module 19 and the heater element 50 via the heater communication line 37. The heater communication line 37 carries electrical current through the heater element 50 and out the heater electrical connector 44.

Referring to FIG. 3b, there is shown a schematic representation of the heater element 50 incorporated within the bowl assembly housing 127 according to another embodiment of the present invention. According to this embodiment of the present invention, the heater element 50 is a portion of a thin film heater 151, similar to the thin film heater 51 previously discussed. The thin film heater 151 is attached to an inner wall 147 of the bowl assembly housing 127. The bowl assembly housing 127 is preferably cylindrical in shape. There are varying methods for attaching the thin film heater 151 to the bowl assembly housing 127. Preferably, the thin film heater 151 is attached to the bowl assembly housing 127 by applying adhesives between the thin film heater 151 and the bowl assembly housing 127. Those skilled in the art will appreciated that the adhesives should not be soluble in diesel fuel, should not adversely react with the chemical makeup of the diesel fuel, and should be capable of withstanding the temperature variations between the heater and the cold climate.

According to still another alternative embodiment of the present invention, similar to the embodiment just discussed, the heater element 50 is a portion of a thin film heater 251 that is molded to the shape of the bowl assembly housing 127, which is preferably cylindrical. However, unlike the embodiment just discussed, the thin film heater 251 is positioned between the inner wall 147 of the bowl assembly housing 127 and the fuel filter 16. Preferably, the thin film heater 251 is made of a material such that it is resiliently urged into contact with the inner wall 147 of the bowl assembly housing 127 by its own resilience from being molded into a flexible flat shape and then rolled up to fit into the bowl assembly housing 127. However, those skilled in the art should appreciate that there are varying methods for securing the thin film heater 251 between the bowl assembly housing 127 and the fuel filter 16, including but not limited to spacers and springs. The thin film heater 251 is attached to the neither the bowl assembly housing 127 nor the fuel filter 16. Thus, when the bowl assembly housing 127 is removed from the filter head assembly 24 in order to replace the fuel filter 16, the thin film heater 251 may be removed from both the bowl assembly housing 127 and the fuel filter 16. This embodiment is advantageous because it allows the bowl assembly housing 127 or the thin film heater 251 to be replaced without replacing the other. Moreover, it eliminates the cost of molding or attaching the thin film heater 251 to the bowl assembly housing 127.

According to the embodiment of the present invention illustrated in FIG. 3b, the heater element 50 is attached or positioned within the bowl assembly housing 127 rather than embedded into the wall of the bowl assembly housing 127. Thus, a heater communication line 137 extends to the interior of the bowl assembly housing 127 in order to pass electric current through the heater element 50 contained within the thin film heater 151, 251. In order to prevent leakage of fuel from the fuel filter 16, a heater electrical connector 144 is preferably molded into the bowl assembly housing 127 near the filter head assembly 24. Just as with the other embodiments, it should be appreciated that the heater electrical connector 144 could be molded at any position on the bowl assembly housing 127 or incorporated into the housings of both the bowl assembly 127 and the filter head 24. The heater electrical connector 144 is wired to the electronic control module 19 and the thin film heater 151, 251 via the heater communication line 137. The heater communication line 137 carries electric current through the heater element 50 contained within the thin film heater 151, 251 and out the heater electrical connector 144. The heater communication line 137 preferably enters and exits the thin film heater 151, 251 at the same end of the thin film heater 151, 251. The portion of the heater communication line 137 that is in the interior of the bowl assembly housing 127 is preferably insulated with a material that is resistant diesel fuel and to the heat produced by the thin film heater 151, 251.

In order to determine whether the fuel flowing through the fuel filter 16 is susceptible to paraffin formation, there should be a means for estimating the temperature of the fuel entering the fuel filter 16. Preferably, accurate control of temperature is achieved by a closed-loop feedback control system coded into the electronic control module 19 in a conventional manner. Recalling FIG. 1, a temperature sensor 41 is preferably positioned within the upstream supply line 14a in order to measure the temperature of the fuel flowing into fuel filter assembly 40. In order to receive the most accurate reading of the temperature of the fuel entering the fuel filter assembly 40, the temperature sensor 41 is preferably positioned at a point in the fuel system 9 close to the low pressure inlet 30 of the fuel filter assembly 40. However, the temperature sensor 41 should be placed at a distance away from the heater element 50 so that the temperature sensor 41 does not detect the temperature of the heater element 50 or the fuel that is heated by the heater element 50 as it passes through the fuel filter 16. Those skilled in the art will appreciate that the temperature sensor 41 can be positioned at any point along the fuel system 9, including, but not limited to, the fuel tank 12. Further, a temperature sensor 41 may not be required when the fuel temperature can be estimated by using an existing temperature sensor, such as the temperature sensor for determining the temperature of coolant or oil. The temperature sensor 41 is in communication with the electronic control module 19 via the temperature sensor line 45. Once the temperature sensor 41 measures the temperature of the fuel flowing into the fuel filter assembly 40, it communicates the actual temperature to the electronic control module 19. The electronic control module 19 compares the actual temperature to a predetermined temperature. The predetermined temperature is preferably the temperature at which paraffins do not form within the fuel.

Referring to FIGS. 3a and 3b, if the actual temperature of the fuel is less than the predetermined temperature at which paraffins form, the electronic control module 19 will continue to send electric current through the heater electrical connector 44, 144 and the heater element 50 via the heater communication line 37, 137. If the electronic control module 19 determines that the actual temperature of the fuel is greater than the predetermined pressure, then the electronic control module 19 will no longer permit electric current to flow through the heater electrical connector 44, 144 and energize the heater element 50. Alternatively, an open-loop feedback circuit may be used to control the temperature of the fuel flowing into the fuel filter 16. In an open-loop feedback circuit, the electronic control module 19 is configured such that it energizes the heater element 50 for a predetermined time period during a cold start. The predetermined time period would be sufficiently long to dissolve the existing paraffins and allow the heat from the engine 10 to warm the fuel so that paraffins do not form once the heater element 50 is de-energized. Once the predetermined time period ends, the electronic control module 19 would no longer allow electric current flow through the heater electrical connector 44, 144 and the heater element 50. In still another alternative, it might be desirable to use a simple temperature sensitive switch that ends current to the heater element 50 above the predetermined temperature.

In still another potential enhancement according to the present invention, the electronic control module 19 includes logic to reduce current to the fuel transfer pump 13 during cold start. The current level should be high enough that adequate fuel is supplied to the fuel injectors 15 to start the engine 10 and maintain it running, but low enough that the fuel flow rate through the fuel filter 16 is such that the heater element 50 can more effectively do its job. This strategy might also permit a lower wattage heater element 50 than that required if the fuel transfer pump 13 output were not reduced.

Industrial Applicability

Referring to FIGS. 1-3, the application of the present invention is described for all the preferred embodiments of the invention. At the time the ignition is activated, the temperature sensor 41 positioned within the upstream supply line 14a detects the temperature of the fuel within the fuel system 9. The temperature sensor 41 communicates the actual temperature to electronic control module 19 via the temperature sensor line 45. The electronic control module 19 then compares the actual temperature within the fuel system to the predetermined temperature. Again, the predetermined temperature is preferably the temperature below which paraffins form in the fuel. If the actual temperature is greater than the predetermined temperature, then the electronic control module 19 will not energize the heater element 50 via the heater communication line 37, 137. However, under cold start conditions, the actual temperature will sometimes be less than the predetermined temperature and be such that paraffins have formed in the fuel. Thus, in order to dissolve the existing paraffins and prevent further formation of paraffins, the electronic control module 19 will energize the heater element 50 by allowing electric current to flow through the heater element 50 via the heater communication line 37, 137 and the heater electrical connector 44, 144. It should be appreciated that the electronic control module 19 can be configured such that it energizes the heater element 50 every time the ignition is activated regardless of the actual temperature within the fuel system 9. The electronic control module 19 might also command the fuel transfer pump 13 to reduce its output rate to make the heater element 50 more effective.

The heater element 50 will begin heating the fuel filter 16 and the fuel, if any, within the fuel filter 16. Because the heater element 50 is at least one of embedded into the bowl assembly housing 27, attached to the bowl assembly housing 127, or secured within the bowl assembly housing 127, the heater element 50 conforms to the preferably cylindrical shape of the bowl assembly housing 27, 127. This maximizes the heating surface area of the heater element 50. Whereas coils or a disc shaped heater placed at one end of the fuel filter 16 is limited to the relatively small heating surface area at that end of the fuel filter 16, the heating surface area of the heater element 50 extends around the circumference and the length of the bowl assembly housing 27, 127. Thus, the heater element 50 will heat the fuel flowing throughout the filter element 36 more quickly.

At the time the ignition is activated, the fuel transfer pump 13 is energized via the pump communication line 38 and the electrical connector 39. Fuel flows from the fuel tank 12 to the low pressure inlet 30 of the fuel filter assembly 40, 140 via the upstream supply line 14a. The flow path through the fuel transfer pump 13 and the fuel filter 16 is illustrated by the arrows in FIG. 2. After the fuel enters the fuel filter assembly 40, 140, the fuel flows via a passage (not shown) through the fuel transfer pump 13 and the filter head assembly 24. The fuel then flows through the outer peripheral fuel passages 42 of the fuel filter element 36 of the fuel filter 16. As the fuel transverses the filter element 36, the fuel is in close proximity to the heater element 50 that is positioned between the annular outer surface 46 of the bowl assembly housing 27, 127 and the fuel filter 16. The heater element 50 is at least one of embedded in the inner wall 47 of the bowl assembly housing 27, attached to the inner wall 147 of the bowl assembly housing 127, or secured between the bowl assembly housing 127 and the fuel filter 16 such as by means of a disc-shaped spring. Because the heater element 50 is already energized and the flow path of the fuel is in close proximity to the heater element 50, the fuel will be warmed to a temperature at which paraffins will not form and paraffins that have formed will dissolve. Therefore, when the fuel transverses the fuel element 36 during a cold start, there will be no paraffins to clog the fuel filter 16 and prohibit the starting of the engine 10. Rather, as the fuel transverses the filter element 36, particulates are removed from the fuel. Due to the specific gravity of the water, the water will separate from the fuel and collect at the bottom of the bowl assembly housing 27, 127. The collected water can eventually be drained from the fuel filter 16 via the water drain valve 33. After the fuel is filtered, it flows through the center fuel passage 43 of the fuel element 36 towards the fuel transfer pump 13. Once in the fuel transfer pump 13, the filtered fuel is pressurized and circulated through the fuel system 9 via the outlet 31. The fuel is eventually delivered to at least one fuel injector15. The fuel injector 15 injects the fuel into the engine cylinder (not shown) in order to start the engine 10.

The fuel transfer pump 13 constantly circulates fuel within the fuel system 9. However, not all of the fuel circulated by the fuel transfer pump 13 is injected into the engine cylinder. The fuel which is not injected is recirculated through the fuel system 9. The remaining unused fuel will be delivered via the return line 20 to the fuel tank 12 for reuse in the engine 10. The heat produced by the working engine 10 will have warmed the fuel that has been cycled through the fuel system 9 of engine 10. When the warmed recycled fuel mixes with the cold fuel within the fuel tank 12, the cold fuel within the fuel tank 12 is warmed. The warmed fuel is then delivered to the fuel filter assembly 40, 140 via the upstream supply line 14a, and the cycle through the fuel system 9 will repeat itself. Each time the recycled fuel mixes with the fuel within the fuel tank 12, the fuel within the fuel tank 12 becomes warmer. As the fuel being delivered to the fuel filter assembly 40, 140 warms, the temperature sensor 41 preferably positioned within the supply line 14 will periodically sample that actual temperature of the fuel flowing into the fuel filter assembly 40, 140. Preferably, the frequency of sampling is selected in order to detect a mean or average temperature that is not too sensitive to insignificant transient effects. It should be appreciated that the temperature sensor 41 could be placed at any point along the fuel system, 9 such as in the fuel tank 12 or a different point along the supply line 14. The temperature sensor 41 will communicate the temperature of the fuel to the electronic control module 19 via the temperature sensor communication line 45. The electronic control module 19 compares the actual temperature to a predetermined temperature. The predetermined temperature is the temperature below which paraffins form in the fuel causing a clogged fuel filter 16. As long as the actual temperature of the fuel is less than the predetermined temperature, the electronic control module 19 will continue to allow current to be supplied across heater electrical connector 44, 144 and through the heater element 50. Thus, the heater element 50 will remain energized and warming the fuel. However, when the actual temperature of the fuel flowing into the fuel filter assembly 40, 140 is greater than the predetermined pressure, the electronic control module 19 will stop the electric current from flowing across the heater electrical connector 44, 144 and energizing the heater element 50. The heater element 50 will no longer warm the fuel. At this point, the heat emitting from the work of the engine 10 is sufficient to sustain the temperature of the fuel so that paraffins do not form within the fuel.

The present invention improves cold starts in cold weather by eliminating the formation of paraffins in diesel fuel that could clog the fuel filer 16. The heater element 50 maximizes its heating surface by conforming to the cylindrical shape of the bowl assembly housing 27, 127 and the filter element 36. Because the heater element 50 extends the circumference and length of the bowl assembly housing 27, 127, it is in close proximity with most of the fuel flowing thorough the filter element 36 and, thereby, maximizes its heating surface area. Further, because the heater element 50 can mold to the shape of the bowl assembly housing 27, 127, it does not consume a significant amount of space within the fuel filter 16 as does a coil or disc-shaped heater. Positioning a coil or disc-shaped heater below the filter element 36 shortens the effective length of the filter element 36, displaces a volume of water and fuel, and unnecessarily utilizes energy heating the water not yet drained through the water drain valve 33. Moreover, because the heater element 50 is incorporated into the inner wall 47, 147 of the bowl assembly housing 27, 127, the heater element 50 can be applied in current fuel filter assemblies by simply replacing the bowl assembly housing 27, 127 with a bowl assembly housing 27, 127 that includes a heater element 50 and a heater electrical connector 44, 144. Unlike incorporating a disc-shaped or coil heater into a fuel filter assembly 40, 140, incorporating a heater element 50 does not require redesigning of the entire fuel filter assembly 40, 140 and/or surrounding components. The heater element 50 does not disrupt the flow pattern of the fuel or the design of the fuel filter 16. In addition, because the heater element 50 is separate from the filter element 36, the heater element 50 does not require replacement along with replacement of the filter element 36. Those skilled in the art should appreciate that although the present invention has been illustrated for use in a fuel system, it could find use in any fluid system having a need to heat the fluid and a filter.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A fuel filter assembly comprising:
a filter assembly housing defining an inlet and an outlet;
a filter positioned in the filter assembly housing; and
a heater element positioned between the annular outer surface and the filter.

2. The fuel filter assembly of claim 1 including an annular outer surface with a cylindrical portion; and
the heater element being positioned adjacent the cylindrical portion.

3. The fuel filter assembly of claim 2 including a water drain valve attached to the filter assembly housing.

4. The fuel filter assembly of claim 3 wherein the heater element is embedded in an inner wall of the filter assembly housing.

5. The fuel filter assembly of claim 3 wherein the heater element is a portion of a thin film heater; and
the thin film heater being at least one of attached to an inner wall of the filter assembly housing and embedded in the inner wall of the filter assembly housing.

6. The fuel filter assembly of claim 1 wherein the heater element is embedded in an inner wall of the filter assembly housing.

7. The fuel filter assembly of claim 1 wherein the heater element is a portion of a thin film heater; and
the thin film heater is attached to an inner wall of the filter assembly housing.

8. The fuel filter assembly of claim 1 wherein the heater element is a portion of a thin film heater; and
the thin film heater is embedded in an inner wall of the filter assembly housing.

9. An engine comprising:
an engine housing; and
a fuel system attached to the engine housing and including a fuel filter assembly with a heater element positioned between a filter and an annular outer surface of a filter assembly housing.

10. The engine of claim 9 wherein the heater element being embedded in an inner wall of the filter assembly housing.

11. The engine of claim 9 wherein the annular outer surface includes a cylindrical portion; and
the heater element being positioned adjacent the cylindrical portion.

12. The engine of claim 11 wherein the fuel filter assembly includes a water drain valve attached to the filter assembly housing.

13. The engine of claim 12 wherein the heater element is embedded in an inner wall of the filter assembly housing.

14. The engine of claim 12 wherein the heater element is a portion of a thin film heater; and
the thin film heater being at least one of attached to an inner wall of the filter assembly housing and embedded in the inner wall of the filter assembly housing.

15. The engine of claim 9 wherein the heater element is a portion of a thin film heater; and
the thin film heater is attached to an inner wall of the filter assembly housing.

16. The engine of claim 9 wherein the heater element is a portion of a thin film heater; and
the thin film heater is embedded in an inner wall of the filter assembly housing.

17. A method of heating fuel comprising the steps of:
positioning a heater element in a fuel filter assembly between a filter and an annular outer surface of a filter assembly housing;
activating the heater element when fuel temperature is below a predetermined temperature.

18. The method of claim 17 wherein the step of positioning includes a step of embedding the heater element into the filter assembly housing.

19. The method of claim 17 wherein the step of positioning includes a step of positioning a thin film heater adjacent the filter.

20. The method of claim 19 wherein the step of positioning includes at least one of attaching the thin film heater to an inner wall of the fuel filter assembly and embedding the thin film heater into the filter assembly housing.
